(19) United States
(12) Patent Application Publication
(10) Pub. No.: US 2021/0170430 A1
(43) Pub. Date: Jun. 10, 2021

(54) CLUSTER HEAD NOZZLE FOR SPRAYING A FLUID, ARRANGEMENT HAVING A CLUSTER HEAD NOZZLE AND METHOD FOR PRODUCING A CLUSTER HEAD NOZZLE

(71) Applicant: Thomas ZEEB, Koengen (DE)

(72) Inventor: Thomas ZEEB, Koengen (DE)

(21) Appl. No.: 17/112,171

(22) Filed: Dec. 4, 2020

(30) Foreign Application Priority Data
Dec. 4, 2019 (DE) 10 2019 218 892.3
Oct. 30, 2020 (DE) 10 2020 213 695.5

(51) Int. Cl. B05B 7/06; B05B 7/04; B05B 7/08

(52) U.S. Cl. CPC B05B 7/061; B05B 7/0869; B05B 7/0876; B05B 7/0483

(57) ABSTRACT

A cluster head nozzle for spraying a fluid, having a single-piece housing and multiple outlet openings which are arranged around a central region on a front side of the housing for individual spray jets, and at least one purge air outlet opening for purge air. The at least one purge air outlet opening and sections of a feed channel for the purge air are provided in the single-piece housing.

### CROSS-REFERENCE TO RELATED APPLICATIONS

This claims priority from German Application No. 10 2019 218 892.3, filed Dec. 4, 2019, and German Application No. 10 2020 213 695.5, filed Oct. 30, 2020, the disclosures of which are hereby incorporated by reference in their entirety.

### TECHNICAL FIELD

The invention relates to a cluster head nozzle for spraying a fluid, having a housing and having multiple outlet openings, which are arranged around a central region on a front side of the housing, for individual spray jets. The invention also relates to an arrangement having a cluster head nozzle and to a method for producing a cluster head nozzle.

### BACKGROUND AND SUMMARY

In the case of conventional cluster head nozzles, particle deposits occur on the surface of the nozzle housing as a result of various effects, such as negative pressure along high-speed flows and cooling of the surface of the nozzle housing by injected media which are cold relative to the surroundings. Taking the example of evaporation coolers in cement plants, cement deposits can occur on the nozzle housings. An example of a conventional cluster head nozzle is illustrated in FIGS. 1 and 2. In each case one individual spray jet or spray composed of atomizing gas and fluid droplets emerges from multiple outlet openings which are arranged in a ring shape around a central region. In front of the central region of the nozzle housing 1, a space 4 forms in which no individual spray jets 3 are present. A negative pressure can form in this space 4 under certain conditions. The negative pressure in the space 4 can result in particles being deposited in the central region within the ring of outlet openings 2. These deposits firstly adhere to the central region of the front side of the housing 1 and can then build up to such an extent that the droplets of the individual spray jets 3 partially impinge thereon and form a wall film on said deposits, from which droplets of large diameter ultimately drip off. These large droplets however no longer fully evaporate within the process chamber, such that incomplete evaporation and ultimately sludge formation occur in the process chamber.

With the invention, it is sought to improve a cluster head nozzle for spraying a fluid, an arrangement and a method for producing a cluster head nozzle.

According to the invention, a cluster head nozzle having the features of Claim 1, an arrangement having the features of Claim 14 and a method having the features of Claim 15 are provided.

A cluster head nozzle according to the invention for spraying a fluid has a single-piece housing and multiple outlet openings for individual spray jets, which outlet openings are arranged around a central region on a front side of the housing, and at least one purge air outlet opening for purge air, wherein the at least one purge air outlet opening and at least sections of a feed channel for the purge air are provided in the single-piece housing.

A very compact design is attained in this way. By virtue of feed channels and the purge air openings being arranged in the housing itself, it is possible for the purge air to be caused to emerge exactly at those locations at which deposits can occur on the outside of the housing. The purge air is operated in particular with pressures up to 1 bar and can be generated using inexpensive compressors, for example a side-channel blower. The branching-off of the purge air from the atomizing air, possibly with a lowering of the pressure, is likewise possible in the context of the invention, but the purge air is advantageously a medium which is fed separately from the atomizing air or the atomizer gas and which is separately controlled.

In one refinement of the invention, at least one of the outlet openings is surrounded by a purge air outlet opening in the form of a ring-shaped gap.

In this way, it is possible for deposits in the region directly surrounding the outlet openings to be reliably prevented. In this way, it can also be ensured that any deposits do not influence the shape of the discharged spray jets. In the context of the invention, a volume flow and a pressure of the purge air emerging from the ring-shaped gap may be coordinated such that a spray or a spray jet emerging from the outlet opening surrounded by the ring-shaped gap is accelerated by the purge air, and thus finer droplets are generated. With the purge air or ring-shaped gap air, the droplets of the envelope of the spray are accelerated and thus broken up. The average droplet size of the spray thus becomes smaller. The ring-shaped gap air also prevents a water film or fluid film from forming around the outlet openings. Instances of caking are thus prevented.

In one refinement of the invention, each purge air outlet opening is assigned a separate feed channel for the purge air.

In this way, a reliable and constant supply of purge air to each purge air outlet opening can be ensured.

In one refinement of the invention, each feed channel is led to an outer side of the housing and/or is connected to a ring-shaped channel in the housing.

By virtue of each feed channel being led to an outer side of the housing, the supply of purge air to the individual feed channels can be performed in a very simple manner via a ring-shaped space which is delimited at one side by a section of the outside of the housing. It is self-evidently also possible for a ring-shaped channel to be provided for the supply of purge air to the individual feed channels.

In one refinement of the invention, a cap is provided which surrounds the housing in certain sections, wherein the feed channels open out at the outside of the housing in an intermediate space between the cap and the housing, or the ring-shaped channel has a flow connection to an intermediate space between the cap and the housing.

By means of a cap which surrounds the outside of the housing in certain sections, it is possible in a very simple manner in terms of construction to provide a ring-shaped space, via which the purge air is then fed.

In one refinement of the invention, the at least one purge air outlet opening for purge air is provided within the central region on the front side of the housing.

By means of the at least one purge air outlet opening in the central region on the front side of the housing, the space between the individual spray jets can be aerated without the purge air having to cross the individual spray jets. The space situated in front of the front side of the housing and within a region encompassed by the individual spray jets can thus be aerated or charged with purge air without the individual spray jets being influenced. In this way, firstly, an unchanged spray pattern of the cluster head nozzle is attained, and secondly, the central region on the front side of the housing can be more effectively kept free from deposits.

In a refinement of the invention, the multiple outlet openings are arranged in a ring shape.

In this way, the individual spray jets emerging from the outlet openings likewise form a ring directly downstream of the outlet openings. The space within said ring of individual spray jets can then, in the case of the cluster head nozzle according to the invention, be charged with purge air such that deposits in the central region on the front side of the housing can be reliably prevented.

In one refinement of the invention, multiple purge air outlet openings are arranged in the central region.

In this way, the central region can be more effectively kept free from deposits.

In one refinement of the invention, the multiple purge air outlet openings are arranged in a ring shape.

The purge air emerging from the purge air outlet openings also overlaps with itself downstream of the purge air outlet openings and can thus form an overall spray air flow, which completely occupies the space within the individual spray jets emerging from the outlet openings and thus reliably prevents deposits within the central region on the front side of the housing.

In one refinement of the invention, at least one purge air outlet opening is provided in a side surface or circumferential surface of the housing.

By means of at least one purge air outlet opening in a side surface or circumferential surface of the housing, it is also possible for deposits on the side surface or circumferential surface of the housing to be reliably prevented.

In one refinement of the invention, within the housing, there are arranged outlet channels which open out at the outlet openings and at least one purge air channel which opens out at the purge air outlet opening, wherein the at least one purge air channel, within the housing, leads through between two outlet channels to the purge air outlet opening.

In a projection of the outlet channels and of the at least one purge air channel as viewed from the side, it is thus the case that the purge air channel intersects the outlet channels, or in other words the purge air channel is, within the housing, led from a region situated radially outside the outlet channels into a region situated radially within the outlet channels. The purge air can thus pass into the central region on the front side of the housing within the outlet openings without the individual spray jets that emerge from the outlet openings being influenced. A particular advantage of such a design is that, in the housing, it is for example possible to provide a mixing chamber or an atomizing chamber for fluid to be atomized, because the purge air channels can duly be led within the housing but for example radially and axially outside the mixing chamber or atomizing chamber. The purge air or the purge air channels thus do not impair the shape of the mixing chamber, such that, by means of all of the individual spray jets emerging from the outlet openings, a uniform spray pattern with the desired droplet size distribution can be attained. For this purpose, the purge air channels are formed into the material of the housing, for example by drilling, or are ideally provided during the production of the housing by additive manufacturing.

In one refinement of the invention, the at least one purge air channel branches off from a channel, arranged within the housing, for the feed of atomizing gas.

In this way, the atomizing gas can also be utilized for the provision of the purge air, such that no additional purge air supply has to be provided.

In one refinement of the invention, the at least one purge air channel leads from a side surface or circumferential surface of the housing to the purge air outlet opening.

Such guidance of the purge air channel makes it possible for a separate purge air supply to be connected to the side surface or circumferential surface of the housing.

In one refinement of the invention, within the housing, there is arranged a ring-shaped channel which connects at least two purge air channels to one another.

Through the provision of a ring-shaped channel, it is possible to create uniform pressure conditions in the at least two purge air channels, such that the purge air emerges from the multiple purge air outlet openings with substantially the same pressure and the same flow rate.

In one refinement of the invention, the ring-shaped channel is arranged radially outside the outlet channels in the housing, and at least one purge air channel leads from the ring-shaped channel to a purge air outlet opening within the central region on the front side of the housing.

In one refinement of the invention, means for adjusting a free cross section of the purge air channel are provided.

In this way, pressure and flow rate of the emerging purge air can be adjusted. Expediently, pressure and flow rate of the emerging purge air is set such that deposits in the central region on the front side of the housing are reliably prevented, but also such that, at the same time, the lowest possible operating costs are achieved.

In one refinement of the invention, a branch bore leads from a side surface or circumferential surface of the housing to the purge air channel, and a stud or a screw is arranged in the branch bore and projects into the purge air channel.

By means of a stud or a screw, a free cross section of the purge air channel can be adjusted in a very simple manner.

According to the invention, the housing is formed as a single piece.

The purge air channels and outlet channels advantageously run within a solid material block, in particular metal block, which forms the housing. In this way, a structurally simple design of the housing is attained, and the purge air can be conducted within the housing into the central region on the front side of the housing without the individual spray jets that emerge from the outlet openings being influenced.

According to the invention, an arrangement having at least one cluster head nozzle according to the invention is also provided, in which arrangement a purge air supply for the feed of purge air and for the setting of the flow rate of fed purge air is provided, wherein the purge air supply has a flow connection to the feed channel for purge air.

By means of such a purge air supply, the flow rate of fed purge air and for example also the outlet speed of the purge air and further parameters can be set. In this way, it is possible to react to boundary conditions in the process environment in which the cluster head nozzle according to the invention is operated.

The housing is advantageously produced by additive manufacturing.

Additive manufacturing, for example by means of 3D printing or laser melting processes (selective laser melting), or generally also beam melting processes, in many cases makes the production of the housing for the cluster head nozzle according to the invention possible in the first place. Specifically, the purge air channels can be arranged within the housing and within the material block of which the housing is composed in substantially any desired manner, and it is for example possible for a purge air channel to be led through between two outlet channels into the central region on the front side of the housing. The formation of a ring-shaped channel which connects multiple purge air channels to one another can also be realized with reasonable technical outlay by additive manufacturing.

In one refinement of the invention, the cluster head nozzle is in the form of a two-substance nozzle and has a mixing chamber arranged within the housing, wherein a channel for the feed of atomizing gas and a channel for the feed of fluid to be atomized open out into the mixing chamber.

The problem on which the invention is based is also achieved by means of a method for producing a cluster head nozzle, in the case of which method the layer-by-layer building of a housing of the cluster head nozzle by additive manufacturing is provided.

Further features and advantages of the invention will emerge from the claims and from the following description of preferred embodiments of the invention in conjunction with the drawings. Individual features of the various embodiments illustrated and described may in this case be combined with one another in any desired manner without going beyond the scope of the invention. This also applies to the combination of individual features without further individual features that they have been described or presented in conjunction with.

### BRIEF DESCRIPTION OF THE DRAWINGS

FIG. 1 shows a front view of a conventional spray nozzle according to the prior art,

FIG. 2 shows a side view of the spray nozzle of FIG. 1 according to the prior art,

FIG. 3 shows a front view of a spray nozzle according to the invention according to a first embodiment,

FIG. 4 shows a view in the section plane IV-IV in FIG. 3,

FIG. 5 shows a partially sectional view of a housing of a cluster head nozzle according to the invention according to a second embodiment,

FIG. 6 shows a partially sectional view of a housing of a cluster head nozzle according to the invention according to a third embodiment,

FIG. 7 shows a side view of the housing of FIG. 6,

FIG. 8 shows a partially sectional view of a cluster head nozzle according to the invention according to a fourth embodiment,

FIG. 9 shows a complete sectional view of the cluster head nozzle according to the invention of FIG. 8, wherein the profile of the section planes has been selected such that these run exactly centrally through an outlet opening on both sides of the nozzle,

FIG. 10 shows a view of a housing of the cluster head nozzle of FIG. 8 in a side view,

FIG. 11 shows an enlarged detail of FIG. 10,

FIG. 12 shows a sectional view of the housing corresponding to FIG. 9,

FIG. 13 shows an enlarged detail from FIG. 12, and

FIG. 14 shows a sectional view of a housing of a cluster head nozzle according to a further embodiment of the invention.

### DETAILED DESCRIPTION

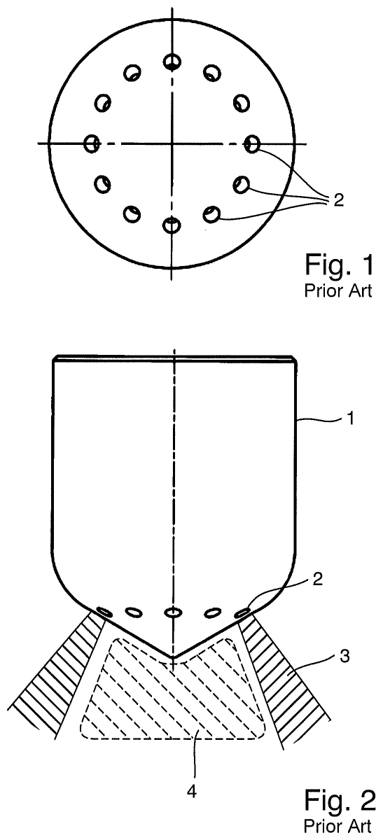

FIGS. 1 and 2 show views, which have already been discussed, of a conventional cluster head nozzle according to the prior art. As has already been discussed, a negative pressure can form in a central region on the front side of the housing 1 within the outlet openings 2 arranged in a ring shape, which pressure then ultimately leads to deposits in the central region on the front side of the housing. Such deposits may, if they reach a certain size, influence the spray pattern of the cluster head nozzle. Specifically, liquid from the individual spray jets 3 is deposited on the deposits and then drips off in the form of large droplets. Such large droplets no longer fully evaporate within the process chamber and ultimately lead to contamination of the process chamber with sludge. If the deposits reach a large size, the outlet openings 2 may be directly influenced and possibly even at least partially blocked.

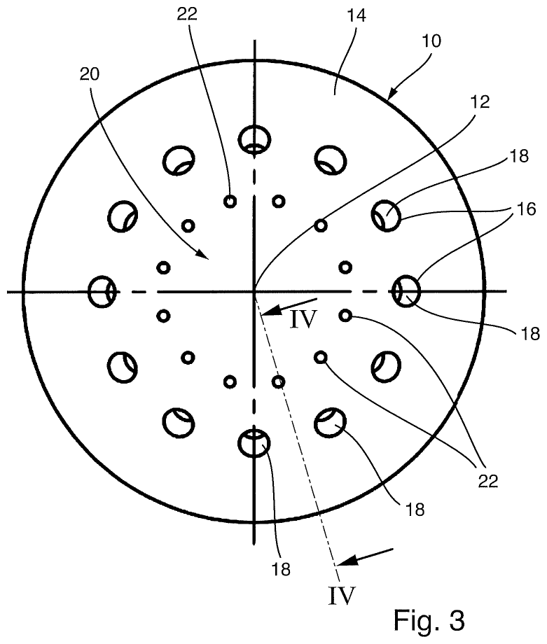

The illustration of FIG. 3 illustrates a cluster head nozzle 10 according to the invention according to the first embodiment of the invention in a front view. In FIG. 3, the view is directed parallel to a central longitudinal axis 12 of the housing 14 onto the front side of the housing 14. On the front side of the housing, a total of twelve outlet openings 16 are arranged in a ring shape and so as to be uniformly spaced apart from one another. The central points of the in each case circular outlet openings 16 lie on an imaginary common circular line around the central longitudinal axis 12. Outlet channels 18 lead in each case to the outlet openings 16, which outlet channels each enclose a same angle with the central longitudinal axis 12, for example an angle between 20° and 45°. Individual spray jets emerging from the outlet openings 16 thus emerge so as to be inclined outwards relative to the central longitudinal axis 12, similarly to the individual spray jets 3 illustrated in FIG. 2.

To prevent the formation of a negative pressure within a central region 20 on the front side of the housing 14, wherein said central region is situated within the ring formed by the outlet openings 16, multiple purge air outlet openings 22 are provided within the central region. Altogether, the housing 14 of the cluster head nozzle 10 has twelve purge air outlet openings 22 which are arranged in a ring shape. The central points of the purge air outlet openings 22 lie on an imaginary circular line which runs concentrically with respect to the central longitudinal axis 12 of the housing 14 and which is also concentric with respect to the imaginary circular line on which the central points of the outlet openings 16 are situated.

In the context of the invention, it is also possible for only a single purge air outlet opening 22 to be arranged in the central region, and the purge air outlet openings may be distributed substantially in any desired arrangement within the central region 20. It is essential that, in a region which, as viewed in an outflow direction, is situated in front of the central region 20 on the front side of the housing 14, that is to say in the space 4 as illustrated in FIG. 2, the formation of a negative pressure is prevented and thus deposits in the central region 20 can be prevented.

This is achieved by means of the aeration of the space 4 illustrated in FIG. 2 by means of purge air from the purge air outlet openings 22. Pressure and flow rate of the purge air emerging from the purge air outlet openings 22 are in this case set such that deposits are reliably prevented, but at the same time the operating costs are kept low.

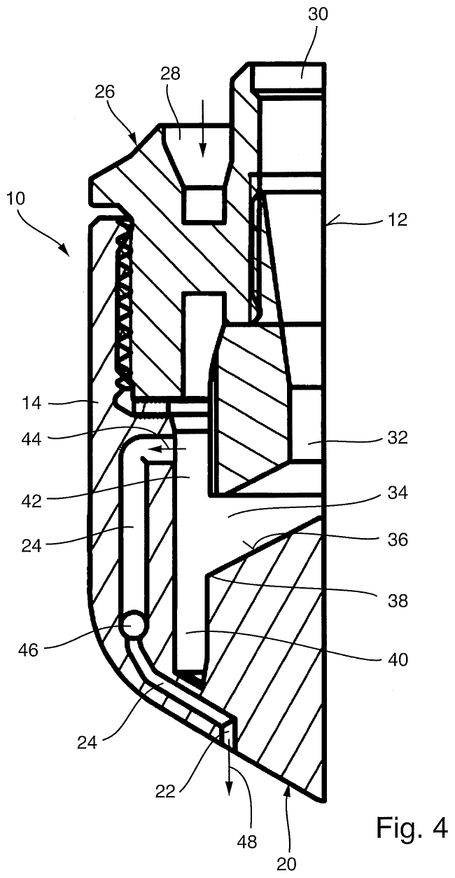

FIG. 4 shows a view onto the section plane IV-IV in FIG. 3. The section plane IV-IV runs, see FIG. 3, through between two outlet channels 18, such that the outlet channels 18 are not visible in the sectional view of FIG. 4. The section plane IV-IV however runs through one of the purge air outlet openings 22 and through a purge air outlet channel 24 via which purge air is fed to the purge air outlet opening 22.

The housing 14 of the cluster head nozzle 10 according to the invention is equipped with an insert 26 which is screwed into the housing 14 from the rear side thereof. On the insert 26, there is provided a connector 28 for atomizing gas and a connector 30 for fluid to be sprayed. The fluid 30 to be atomized is fed concentrically with respect to the central longitudinal axis 12 of the housing and passes via an inlet nozzle 32 into a mixing chamber 34 in the housing. The mixing chamber 34 has a distributing cone 36 which is arranged opposite the inlet nozzle 32. The distributing cone 36 is arranged concentrically with respect to the central longitudinal axis 12. The fluid to be sprayed, which emerges from the inlet nozzle 32, strikes the distributing cone 36, the tip of which is directed counter to the inlet nozzle 32. The fluid to be sprayed forms, on the distributing cone 36, a fluid film which flows radially outwards over the distributing cone 36. At an encircling edge 38 of the distributing cone 36, the fluid departs from the surface of the distributing cone 36 and enters a ring-shaped section 40 of the mixing chamber 34, at the base of which the outlet channels 18 begin, which then lead to the outlet openings 16. The atomizing gas fed via the connector 28 is conducted into a ring-shaped channel 42, which is arranged substantially in alignment with the ring-shaped section 40 of the mixing chamber 34, and said atomizing gas impinges in the form of a ring-shaped jet on the fluid departing from the encircling edge 38 of the distributing cone 36. In the ring-shaped section 40, the atomizing gas and the fluid to be sprayed consequently mix to form a mixture of droplets of the fluid to be sprayed and atomizing gas. This mixture then enters the outlet channel 18 and ultimately emerges in the form of individual spray jets from the outlet openings 16.

The purge air channel 24 branches off from the ring-shaped channel 42 via which the atomizing gas is fed. As per an arrow 44, atomizing gas at positive pressure thus enters the purge air channel 24. The purge air channel 24 firstly leads radially outwards away from the ring-shaped channel 42, but then has a 90° bend and runs parallel to the central longitudinal axis 12 to a ring-shaped channel 46. The ring-shaped channel 46 forms an encircling ring which is arranged within the material block of the housing 14 and which is arranged concentrically with respect to the central longitudinal axis 12. The ring-shaped channel 46 runs radially outside the ring-shaped section 40 of the mixing chamber 34 and thus also in a region which is situated radially outside the outlet channels 18 and the outlet openings 16, cf. FIG. 3. By means of the ring-shaped channel 46, the purge air from the purge air channel 24 is distributed uniformly. Multiple purge air channels 24 branch off from the ring-shaped channel 46, wherein only one purge air channel 24 is visible in the illustration of FIG. 4. As per FIG. 3, a total of twelve purge air outlet openings 22 are provided, to which in each case one purge air channel 24 leads. A total of twelve purge air channels 24 thus lead away from the ring-shaped channel 46, which purge air channels lead in each case to one purge air outlet opening 22.

It can be seen in the illustration of FIG. 4 that the purge air channels 24 leading away from the ring-shaped channel 46 are in each case, a short distance behind the front side of the housing 14, led parallel to the front side, and then have a sharp bend such that purge air can emerge from the respective purge air opening 22 as per an arrow 48. In their final section directly downstream of the purge air outlet openings 22, the purge air channels 24 run parallel to the central longitudinal axis 12. The purge air thus emerges from the purge air outlet opening 22 parallel to the central longitudinal axis 12, as per the arrow 48. In the context of the invention, an angle at which the purge air emerges from the purge air outlet openings 22 can be varied.

By means of the purge air emerging as per the arrow 48, the central region 20 on the front side of the housing 14 can be aerated, and deposits in the central region 20 are thus reliably prevented.

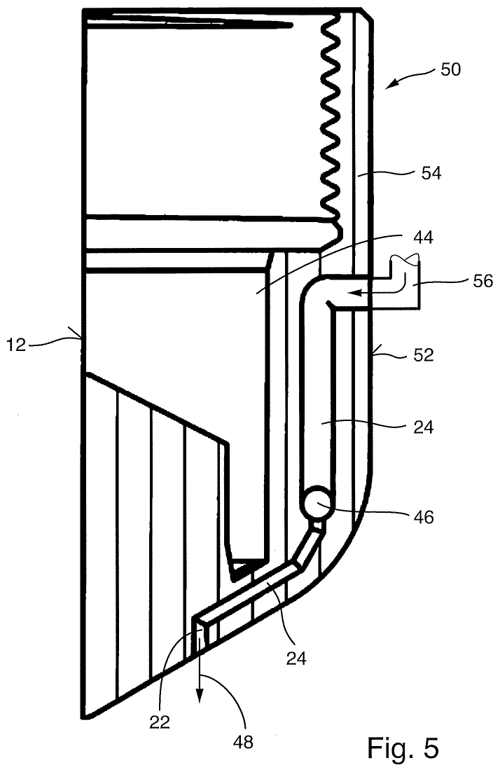

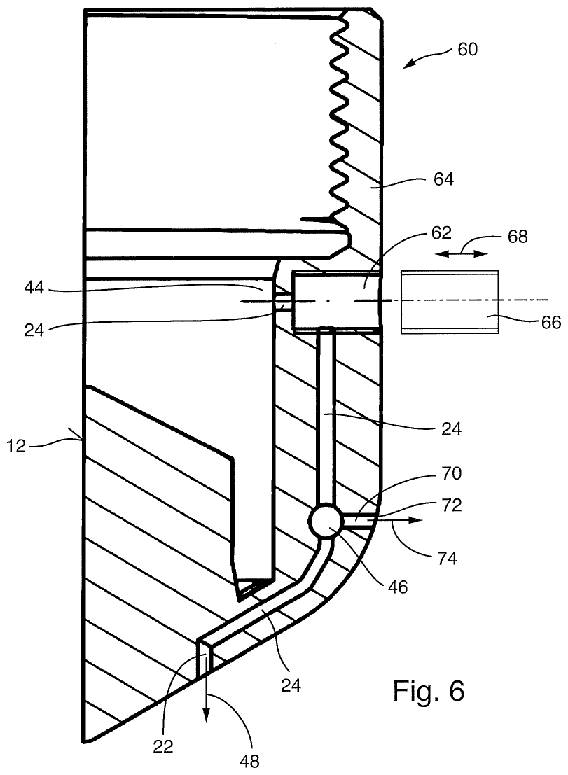

The illustration of FIG. 5 shows a partial sectional view of a cluster head nozzle 50 according to the invention according to a further embodiment of the invention. The cluster head nozzle 50 is only partially illustrated, and specifically, the insert 26 of the cluster head nozzle 10 of FIG. 4 is not illustrated again. The insert 26 is however identical design in the case of the cluster head nozzle 50, and will therefore not be illustrated and will not be discussed again.

By contrast to the cluster head nozzle 10 of FIG. 4, the cluster head nozzle 50 of FIG. 5 has a housing 54, in the case of which the purge air is not branched off from the ring-shaped channel 44 via which the atomizing gas is fed, it rather being the case that the purge air channel 24 ends at a circumferential surface 52 of the housing 50. The purge air channel 24 then firstly leads radially inwards, then parallel to the central longitudinal axis 12 to the ring-shaped channel 46, in order to then end, as has already been discussed on the basis of FIG. 4, at the purge air outlet opening 22, from which purge air then emerges as per the arrow 48.

It is thus possible, on the one hand, for purge air to be drawn into the purge air channel 24 from the surroundings of the housing 54. This is possible because, as has been discussed on the basis of FIG. 2, a negative pressure prevails within the space 4 between the individual spray jets 3 during spraying operation. In the context of the invention, however, the purge air channel 24 may also be fed by means of a purge air feed 56, which is only partially indicated in FIG. 5 and by means of which the purge air is fed at the desired pressure and with the desired flow rate.

The illustration of FIG. 6 shows a partial sectional view of a cluster head nozzle 60 according to a further embodiment of the invention. An insert 26 of the housing 64 of the cluster head nozzle 60 is not illustrated in FIG. 6, but is of identical construction to the insert 26 that has already been discussed in conjunction with the cluster head nozzle 10 of FIG. 4.

As in the case of the cluster head nozzle 10 of FIG. 4, purge air is branched off from the ring-shaped channel 44 via which the atomizing gas is fed. The purge air branched off from the atomizing gas is then conducted via the purge air channel 24 to the ring-shaped channel 46 and via the second section of the purge air channel 24 downstream of the ring-shaped channel 46 to in each case one outlet opening 22, from which purge air then emerges as per the arrow 48.

In order to be able to influence flow rate and pressure of the purge air in the first section of the purge air channel 24 and also downstream thereof, a bore 62 is provided which extends into the housing 64 proceeding from a circumferential surface thereof. The bore is in the form of a blind bore and intersects the first section of the purge air channel 24 and that section of the purge air channel 24 which leads away from the ring-shaped channel 44. That section of the purge air channel 24 which leads away from the ring-shaped channel 44, and that section of the purge air channel 24 which extends parallel to the central longitudinal axis 12, thus open into the blind bore 62. A grub screw 66 can be screwed to a greater or lesser extent into the blind bore 62, as indicated by means of a double arrow 68. It is thus possible for the free cross section of the first section of the purge air channel 24 to be adjusted by means of the grub screw 66. In this way, pressure and flow rate of the purge air in the first section of the purge air channel 24 and downstream thereof can be adjusted. Specifically if atomizing gas is fed at very high pressure in the ring-shaped channel 44, the cluster head nozzle 60 is advantageous because only a small proportion of the atomizing gas is discharged through the purge air channel 24.

Not only the second sections of the purge air channels 24, which then end at the purge air outlet openings 22, lead away from the ring-shaped channel 46. Furthermore, second purge air channels 70 lead away from the ring-shaped channel 46, which second purge air channels extend in a radial direction and lead to second purge air outlet openings 72 in the circumferential surface of the housing 64. Multiple second purge air channels 70 and multiple second purge air outlet openings 72 are provided, from which purge air then emerges, as per an arrow 74, in a radial direction with respect to the central longitudinal axis 12 of the housing 64. By means of the purge air emerging as per the arrow 74, deposits on the circumferential surface or side surface of the housing 64 can also be prevented.

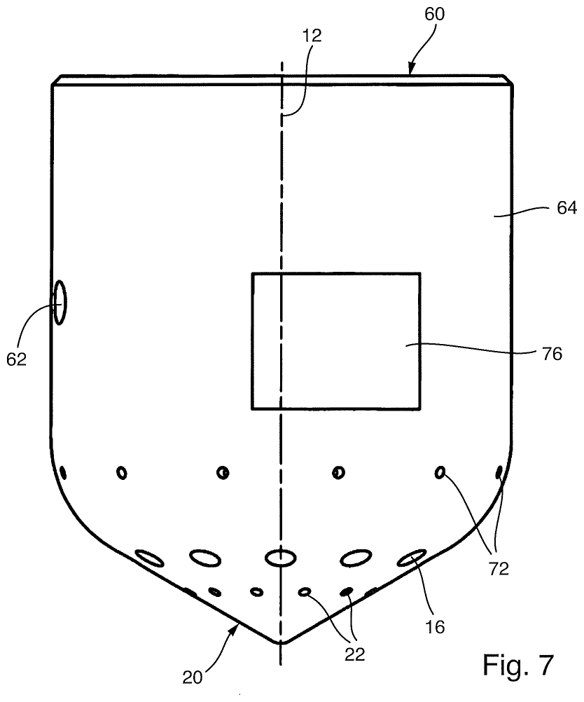

FIG. 7 shows a side view of a cluster head nozzle 60 of FIG. 6. It is possible to see a proportion of the outlet openings 16, which are arranged in a ring shape around the central longitudinal axis 12 on the front side of the housing 64 and from which individual spray jets then emerge in each case. Each individual spray jet is composed of a mixture of droplets and atomizing gas. It is likewise possible to see the multiple purge air outlet openings 22, which are arranged in a ring shape within the central region 20 on the front side of the housing 64.

It is also possible to see some of the second purge air outlet openings 72 arranged on the circumferential surface of the housing 64, which second purge air outlet openings are distributed over the circumference of the housing 64 in a uniformly spaced-apart manner along an imaginary circular line. In the circumferential surface of the housing 64, it is also possible to see the start of the blind bore 62, cf. FIG. 6. The grub screw 66 is not illustrated in FIG. 7.

The housing 64 has a drive formation 76 in the form of a flattened surface and an oppositely situated flattened surface which is not visible in FIG. 7. The drive formation 76 serves for the engagement of an open end wrench for the purposes of firmly holding the housing 64 as the insert 28 is screwed in, which insert is then for example in turn connected to two concentric pipelines for the feed of fluid to be atomized and atomizing gas.

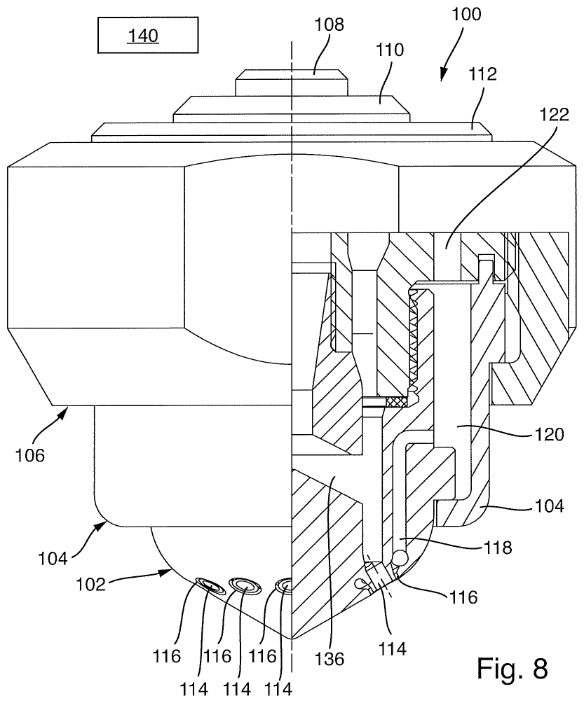

The illustration of FIG. 8 shows a partially sectional view of a cluster head nozzle according to the invention according to a further embodiment of the invention. The cluster head nozzle 100 has a housing 102, a cap 104 and a sleeve nut 106. By means of the sleeve nut 106, the housing 102 and the cap 104 are fastened to a pipeline (not illustrated). Here, the pipeline has three individual pipes arranged coaxially with respect to one another. By means of a central pipe, the liquid to be sprayed is fed to a liquid inlet 108. A ring-shaped space between the central pipe and the pipe which follows this in a radial direction serves for the feed of atomizing air to an atomizing air connection 110. A second ring-shaped space between the central pipe and the outer pipe serves for the feed of purge air to a purge air connection 112. The purge air is provided and controlled with regard to flow rate and pressure by means of a purge air supply 140, and is fed to the purge air connection 112 in a manner which is not illustrated.

In the context of the invention, liquid to be atomized, atomizing air and purge air may self-evidently also be fed in some other way, for example via non-coaxial pipelines.

The cluster head nozzle 100 may for example be arranged at the end of a so-called spray lance in which the lines for the feed of fluid, atomizing air and purge air are arranged and which projects into a process chamber.

The liquid to be atomized is, in the same way as in the case of the cluster head nozzles discussed on the basis of FIGS. 1 to 7, atomized by means of atomizing gas in a mixing chamber 136 and fed to multiple outlet openings 114. A spray jet thus emerges from each of the outlet openings 114.

By contrast to the cluster head nozzles of FIGS. 1 to 7, it is the case in the cluster head nozzle 100 that each outlet opening 114 is surrounded by a purge air outlet opening 116 in the form of a ring-shaped gap. Each of the purge air outlet openings 116 in the form of a ring-shaped gap is in this case arranged concentrically with respect to the associated outlet opening 114. The total of ten outlet openings 114 are in this case arranged in a ring shape on a front side of the housing 102. As stated, each of the outlet openings 114 is surrounded by an associated purge air outlet opening 116 in the form of a ring-shaped gap.

In the context of the invention, aside from the purge air outlet openings 116, yet further outlet openings for purge air may be provided on the outside of the housing, for example also in the central region on the front side of the housing, which further outlet openings surround the outlet openings 114 and purge air outlet openings 116 arranged in a ring shape. Further purge air outlet openings may for example also be provided on the outside of the housing 112 between the lower delimitation, in FIG. 8, of the cap 104 and the purge air outlet openings 116.

By means of the purge air outlet openings 116 in the form of a ring-shaped gap, each outlet opening 114 is, during the operation of the cluster head nozzle 100, surrounded by a ring of purge air. Deposits in the region directly surrounding the outlet opening 114 are thus reliably prevented. This also prevents deposits from adversely affecting the individual spray jets emerging from the outlet openings 114 during long-term operation of the cluster head nozzle 100. The droplets in the envelope of the spray jets or of the spray are accelerated by the purge air from the ring-shaped gap and thus split up. The average droplet size in the spray is thus reduced.

Each of the purge air outlet openings 114 is connected by means of a feed channel 118, which runs within the single-piece housing 102, to a ring-shaped space 120 between the cap 104 and the outer surface of the housing 102. Said ring-shaped space 120 is in turn supplied with purge air via a feed channel 122 from the purge air connection 112 and the purge air supply 140. Purge air can thus be supplied to each feed channel 118 via the ring-shaped space 120.

By virtue of the fact that the feed channels 118 run within the single-piece housing 102, an extremely compact and structurally simple arrangement is created. The purge air openings 116 in the form of a ring-shaped gap are also provided in the single-piece housing 102.

The housing 102 cannot be produced by cutting machining. The housing 102 is produced by additive methods. Here, the purge air openings 116 in the form of a ring-shaped gap and the feed channels 118 are jointly formed during the layer-by-layer building of the housing 102.

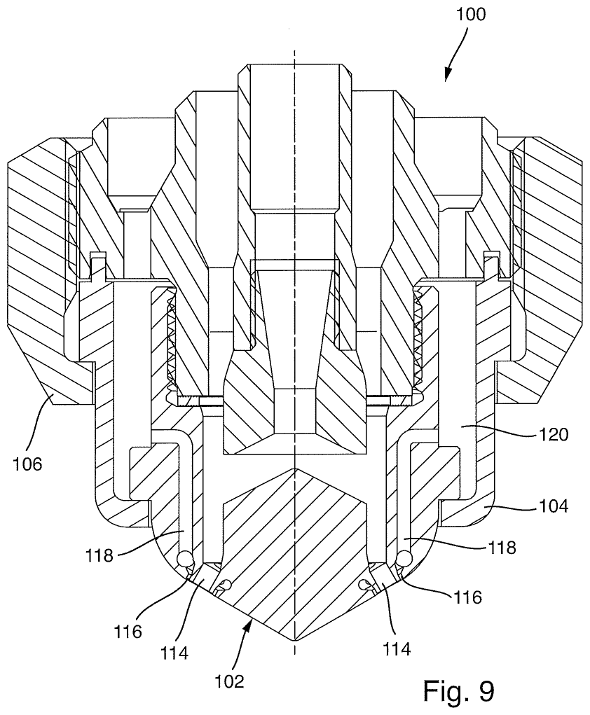

The illustration of FIG. 9 shows a further sectional view of the cluster head nozzle 100 of FIG. 8. Here, however, the section planes on the right-hand side and on the left-hand side of FIG. 9 do not lie in one plane. Rather, the section planes to the left and to the right of the centreline are selected such that the section area to the left and the section area to the right of the central longitudinal axis run exactly centrally through an outlet opening 114.

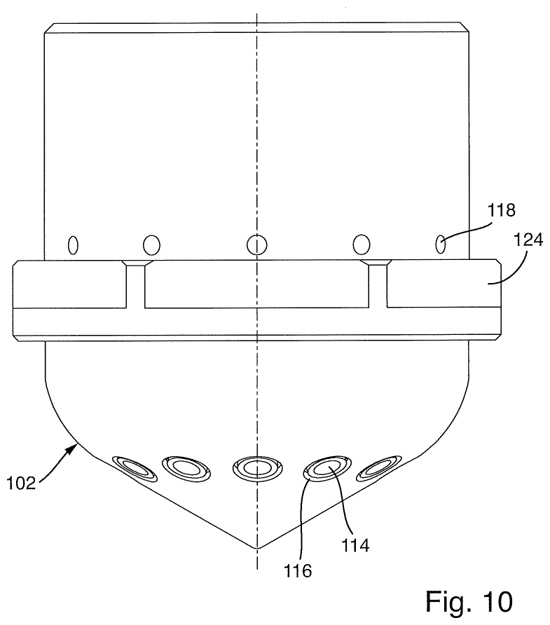

FIG. 10 shows a side view of the housing 102. In this view, it is possible to see a total of five outlet openings 114, each with a purge air outlet opening 116 in the form of a ring-shaped gap and surrounding the outlet opening 114, and a fastening ring 124, which on its inside is equipped with an internal thread and on its outside is equipped with flattened portions, in order to enable the housing 102 to be arranged on a fastening flange.

The mouth openings of the feed channels 118 can also be seen in FIG. 10. Said feed channels 118 end at an outside of the housing in order to then, see FIGS. 8 and 9, open into the ring-shaped space 120.

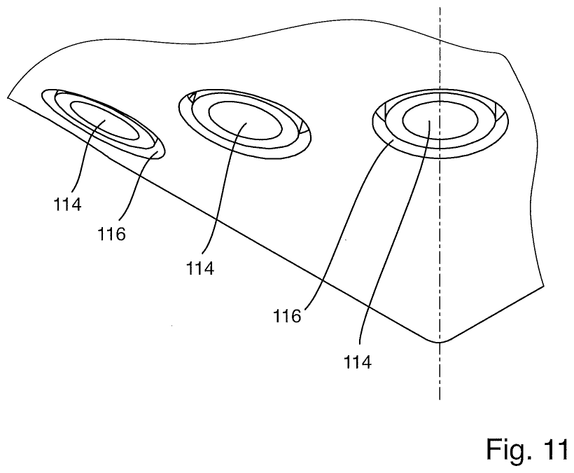

The illustration of FIG. 11 shows an enlarged detail of FIG. 10. Only three outlet openings 114 are illustrated, each of which is surrounded by a purge air outlet opening 116.

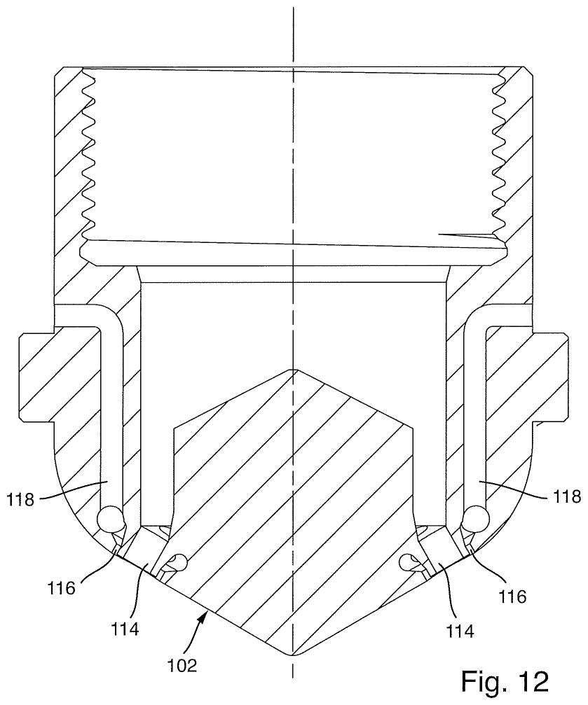

FIG. 12 shows a sectional view of the housing 102.

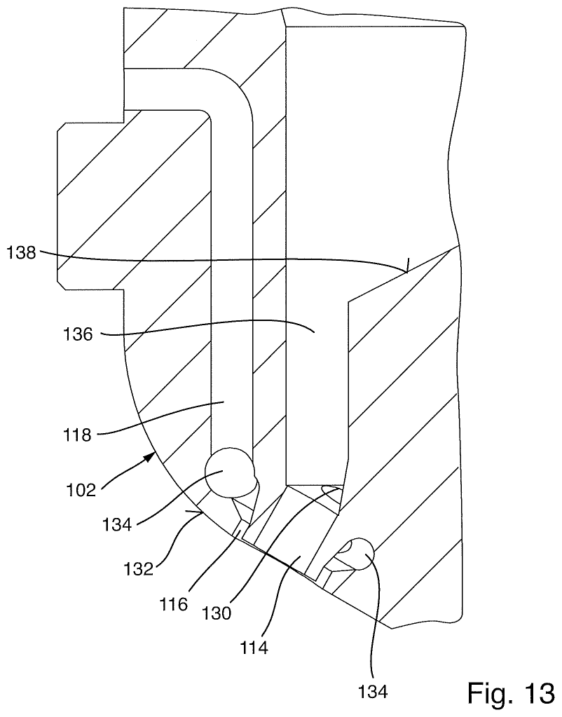

FIG. 13 shows an enlarged detail of the sectional view of FIG. 12. Adjacent to a first outlet opening 114, it is possible to see, in certain sections, the start of a channel 130 which leads to a further outlet opening 114. Furthermore, it can be clearly seen that the purge air outlet opening 116, in the region directly adjoining the outside 132 of the housing 102, has the form of a ring-shaped gap with mutually parallel side walls. Upstream of this actual ring-shaped gap region, the ring-shaped space widens in order to then transition into a ring-shaped channel 134 which then in turn has a flow connection to the feed channel 118. A cross section of said ring-shaped channel 134, which likewise surrounds the outlet opening 114, is however not constant. In the opening-out region of the feed channel 118, the cross section of said ring-shaped channel 134 is at its largest. By contrast, opposite the opening-out region of the feed channel 118, that is to say ultimately at 180° of the circumference of the ring-shaped channel 134, the cross section of the ring-shaped channel 134 is at its smallest. In this way, a uniform supply of purge air to the purge air outlet opening 116 can be ensured. It is achieved in this way that the same flow rate of purge air emerges over the entire circumference of the purge air outlet opening 116.

From the illustration of FIG. 13, it can be clearly seen that the housing 102 can be produced not by cutting but rather, at least in the region of the feed channel 118, of the ring-shaped channel 134 and of the purge air outlet opening 116, by additive methods.

For example, it would be possible for a blank of the housing 102 to be produced by means of additive methods, and said blank is then already provided with the feed channels 118, the ring-shaped channels 134 and the purge air outlet openings 116. By contrast, the outlet openings 114 and also the ring-shaped mixing chamber 136 arranged upstream of the outlet openings 114 and the conical impingement surface 138 for entering fluid may be produced in a conventional manner by cutting. In the context of the invention, it is self-evidently also possible for the complete housing 102 to be produced by means of additive methods.

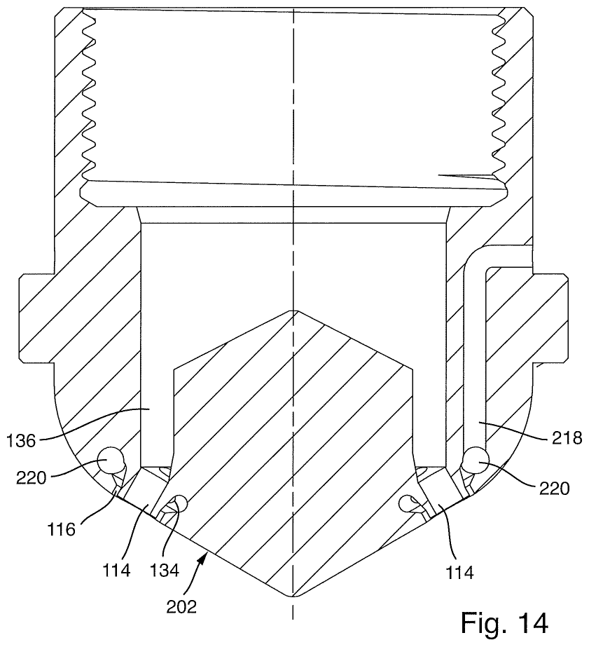

FIG. 14 shows a sectional view of a housing 202 according to a further embodiment of the invention. The housing 202 can be used instead of the housing 102 in the cluster head nozzle 100 illustrated in FIG. 8 and FIG. 9.

The housing 202 is of very similar construction to the housing 102, such that only the differences in relation to the housing 102 will be discussed.

In the case of the housing 102, each ring-shaped channel 134 is connected to a separate feed channel 118. Each feed channel 118 then leads, see FIG. 8 and FIG. 9, into the ring-shaped space 120 between the housing 102 and the cap 104.

By contrast to this, the housing 202 has only a single feed channel 218, which likewise opens out into the ring-shaped space 120. The feed channel 218 is however connected to a ring-shaped channel 220, which runs in encircling fashion through 360°. The ring-shaped channel 220 thus runs in encircling fashion radially outside the ring-shaped space 136 in the wall of the housing 202. From this ring-shaped channel 220, the ring-shaped channels 134 then branch off, which are provided for feeding purge air to the individual ring-shaped gaps 116.

In the illustration of FIG. 14, the ring-shaped channel 134 and the ring-shaped channel 220 thus coincide in the region of the largest cross section of the ring-shaped channel 220.

The housings 14, 54, 64, 102, 202, discussed on the basis of FIGS. 3 to 14, of the cluster head nozzles 10, 50, 60 according to the invention are produced in each case by additive manufacturing. The housings are thus formed in layer-by-layer fashion by means of 3D printing or by means of laser melting processes. In this way, it is also possible for the purge air channels 24 to be formed in the shape illustrated in FIGS. 4 to 7 and with the illustrated profile and also for the ring-shaped channel 46 to be formed during the layer-by-layer production process. The purge air channels 24, the ring-shaped channel 46 and the outlet channels 18 are thus all situated in one material block of the housing. The housings of the cluster head nozzles according to the invention of FIGS. 4 to 14 would not be producible by cutting manufacturing processes.

What is claimed is:

1. Cluster head nozzle (10, 50, 60, 100) for spraying a fluid, having a single-piece housing (14; 54; 64; 102; 202) and having multiple outlet openings (16; 114) for spray jets, which outlet openings are arranged around a central region (20) on a front side of the housing (14; 54; 64; 102; 202), and having at least one purge air outlet opening (22; 116) for purge air, characterized in that the at least one purge air outlet opening (22; 116) and at least sections of a feed channel (24; 118) for the purge air are provided in the single-piece housing (14; 54; 64; 102; 202).

2. Cluster head nozzle according to claim 1, characterized in that at least one of the outlet openings (114) is surrounded by a purge air outlet opening (116) in the form of a ring-shaped gap.

3. Cluster head nozzle according to claim 2, characterized in that each outlet opening (114) is surrounded by a purge air outlet opening (116) in the form of a ring-shaped gap.

4. Cluster head nozzle according to at least one of the preceding claims, characterized in that each purge air outlet opening (116) is assigned a separate feed channel (118) for the purge air.

5. Cluster head nozzle according to claim 4, characterized in that each feed channel (24; 118; 218) is led to an outer side of the housing (54; 64; 102) and/or is connected to a ring-shaped channel (46; 220) in the housing (64; 202).

6. Cluster head nozzle according to claim 5, characterized in that a cap (104) is provided which surrounds the housing (102; 202) in certain sections, wherein the feed channels (118) open out at the outside of the housing (102; 202) in an intermediate space (120) between the cap (104) and the housing (102; 202), or the ring-shaped channel (220) has a flow connection to an intermediate space (120) between the cap (104) and the housing (102; 202).

7. Cluster head nozzle according to any of the preceding claims, characterized in that at least one purge air outlet opening (22) for purge air is provided within the central region (20) on the front side of the housing (14; 54; 64).

8. Cluster head nozzle according to at least one of the preceding claims, characterized in that the multiple outlet openings (16; 114) are arranged in a ring shape.

9. Cluster head nozzle according to at least one of the preceding claims, characterized in that multiple purge air outlet openings (22) are arranged in the central region (20).

10. Cluster head nozzle according to claim 9, characterized in that the multiple purge air outlet openings (22) are arranged in a ring shape.

11. Cluster head nozzle according to at least one of the preceding claims, characterized in that at least one purge air outlet opening (72) is provided in a side surface or circumferential surface of the housing (64).

12. Cluster head nozzle according to at least one of the preceding claims, characterized in that the housing (14; 54; 64; 102; 202) is produced by additive manufacturing.

13. Cluster head nozzle according to at least one of the preceding claims, characterized in that the cluster head nozzle (10; 50; 60; 100) is formed as a two-substance nozzle and has a mixing chamber (34; 136) arranged within the housing (14; 54; 64; 102; 202), wherein a channel for the feed of atomizing gas and a channel for the feed of fluid to be atomized open out into the mixing chamber (34; 136).

14. Arrangement having a cluster head nozzle according to at least one of the preceding claims, characterized in that a purge air supply (140) for the feed of purge air and for the setting of the flow rate of fed purge air is provided, wherein the purge air supply (140) has a flow connection to the feed channel (122) for purge air.

15. Method for producing a cluster head nozzle, characterized by layer-by-layer building of a housing (14; 54; 64; 102; 202) of the cluster head nozzle (10; 50; 60; 100) by additive manufacturing.
